(19) United States
(12) Patent Application Publication
(10) Pub. No.: US 2011/0074342 A1
(43) Pub. Date: Mar. 31, 2011

(54) WIRELESS ELECTRICITY FOR ELECTRONIC DEVICES

(75) Inventor: Scott MacLaughlin, Windsor, CO (US)

(73) Assignee: Nellcor Puritan Bennett LLC, Boulder, CO (US)

(21) Appl. No.: 12/571,047

(22) Filed: Sep. 30, 2009

(51) Int. Cl. H02J 7/00; H01F 27/42

(52) U.S. Cl. 320/108; 307/104

(57) ABSTRACT

A system and method for the wirelessly charging electronic devices. For example, the electronic device may be a pulse oximeter with a wireless sensor. The wireless sensor may include a sensor power source adapted to power the wireless sensor. The wireless sensor may also include a sensor charging device adapted to receive a wireless electromagnetic charging signal and charge the power source via the wireless electromagnetic charging signal.

### BACKGROUND

The present disclosure relates generally to generation of wireless electricity and, more particularly, to the powering of electronic devices by the wireless electricity.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

In the field of medicine, doctors often desire to monitor certain physiological characteristics of their patients. Accordingly, a wide variety of devices have been developed for monitoring many such physiological characteristics. Such devices provide doctors and other healthcare personnel with the information they need to provide the best possible healthcare for their patients. As a result, such monitoring devices have become an indispensable part of modern medicine.

One technique for monitoring certain physiological characteristics of a patient is commonly referred to as pulse oximetry, and the devices built based upon pulse oximetry techniques are commonly referred to as pulse oximeters. Pulse oximetry may be used to measure various blood flow characteristics, such as the blood-oxygen saturation of hemoglobin in arterial blood, the volume of individual blood pulsations supplying the tissue, and/or the rate of blood pulsations corresponding to each heartbeat of a patient. In fact, the “pulse” in pulse oximetry refers to the time varying amount of arterial blood in the tissue during each cardiac cycle.

Pulse oximeters typically utilize a non-invasive sensor that transmits light through a patient's tissue and that photoelectrically detects the absorption and/or scattering of the transmitted light in such tissue. One or more of the above physiological characteristics may then be calculated based upon the amount of light absorbed or scattered. More specifically, the light passed through the tissue is typically selected to be of one or more wavelengths that may be absorbed or scattered by the blood in an amount correlative to the amount of the blood constituent present in the blood. The amount of light absorbed and/or scattered may then be used to estimate the amount of blood constituent in the tissue using various algorithms.

Because of the particular physiological parameters that pulse oximeters are capable of determining, the use of pulse oximeters has become important in places besides hospitals. Traditional pulse oximeters obtain power by plugging into a wall socket. However, wireless sensors have been developed for use in measuring physiological parameters of a patient. Powering of these devices may present a challenge as there are no wires connected to the sensor to provide power to the sensors. Accordingly, alternate powering methods may be necessitated.

Furthermore, pulse oximeters may be used to monitor and treat patients outside of a hospital setting, such as in developing nations where constant and regular sources of electricity may be difficult to obtain. This lack of a constant and regular source of electricity renders traditional plug-in pulse oximeters at a disadvantage. While pulse oximeters powered by replaceable batteries can overcome this problem, there still exists a problem that the batteries in such pulse oximeters need to be replaced frequently. When this occurs in situations where replacement batteries are not readily available, these pulse oximeters become similarly disadvantaged as the traditional plug-in pulse oximeters.

Additionally, other devices, such as medical implants, portable electronic devices (such as portable computers, media players, cellular phones, personal data organizers, and the like), and/or mobile gaming systems may also fail when power sources, such as batteries, die. As such, alternative powering methods would be advantageous.

### BRIEF DESCRIPTION OF THE DRAWINGS

Advantages of the disclosed techniques may become apparent upon reading the following detailed description and upon reference to the drawings in which:

FIG. 1 illustrates a perspective view of a wireless power system including an electronic device, such as a pulse oximeter, in accordance with an embodiment;

FIG. 2 illustrates a simplified block diagram of the pulse oximeter in FIG. 1, according to an embodiment; and

FIG. 3 illustrates a block diagram of the wireless power system of FIG. 1.

### DETAILED DESCRIPTION OF SPECIFIC EMBODIMENTS

One or more specific embodiments of the present techniques will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Present embodiments relate to a system and method for wirelessly powering electronic devices. The system may include a charging station, which may generate electromagnetic charging signals, and a device that may receive the generated electromagnetic charging signals and may utilize the electromagnetic charging signals to generate power to charge a power source, such as a rechargeable battery, in the device. Additionally, the device may include control circuitry that may transmit various signals to the charging station that activate and deactivate the charging station based on the charging requirements of the device. The devices may include, but are not limited to, pulse oximetry sensors, pulse oximetry monitors, portable pulse oximeters, medical implants, portable computers, portable phones, and/or portable gaming devices. Each of these devices may include circuitry for communication with the charging station as well as circuitry for reception and utilization of wireless energy.

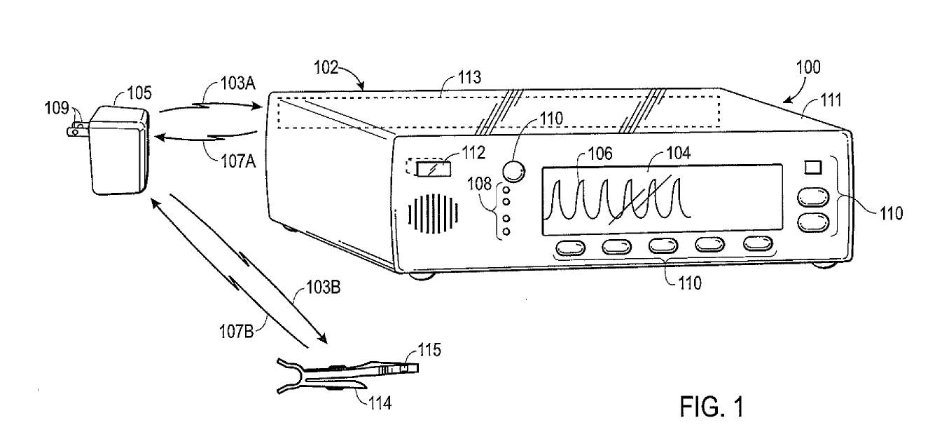

Turning to FIG. 1, a perspective view of a medical device is illustrated in accordance with an embodiment. The medical device may be a pulse oximeter 100. The pulse oximeter 100 may include a monitor 102, such as those available from Nellcor Puritan Bennett LLC. The monitor 102 may be configured to display calculated parameters on a display 104. As illustrated in FIG. 1, the display 104 may be integrated into the monitor 102. However, the monitor 102 may be configured to provide data via a port to a display (not shown) that is not integrated with the monitor 102. The display 104 may be configured to display computed physiological data including, for example, an oxygen saturation percentage, a pulse rate, and/or a plethysmographic waveform 106. As is known in the art, the oxygen saturation percentage may be a functional arterial hemoglobin oxygen saturation measurement in units of percentage SpO₂, while the pulse rate may indicate a patient's pulse rate in beats per minute. The monitor 102 may also display information related to alarms, monitor settings, and/or signal quality via indicator lights 108.

To facilitate user input, the monitor 102 may include a plurality of control inputs 110. The control inputs 110 may include fixed function keys, programmable function keys, and soft keys. Specifically, the control inputs 110 may correspond to soft key icons in the display 104. Pressing control inputs 110 associated with, or adjacent to, an icon in the display may select a corresponding option. The monitor 102 may also include a casing 111. The casing 111 may aid in the protection of the internal elements of the monitor 102 from damage.

The monitor 102 may further include a transceiver 112. The transceiver 112 may allow for wireless operation signals to be transmitted to and received from an external sensor 114. In this manner, the monitor 102 and the sensor 114 may communicate wirelessly. The sensor 114 may be of a disposable or a non-disposable type. Furthermore, the sensor 114 may obtain readings from a patient that can be used by the monitor 102 to calculate certain physiological characteristics such as the blood-oxygen saturation of hemoglobin in arterial blood, the volume of individual blood pulsations supplying the tissue, and/or the rate of blood pulsations corresponding to each heartbeat of a patient. As will be discussed in greater detail below, the monitor 102 and the sensor 114 may each include a charging device 113 and 115, respectively, for reception of wireless energy and charging of a power source in each of the monitor 102 and the sensor 114.

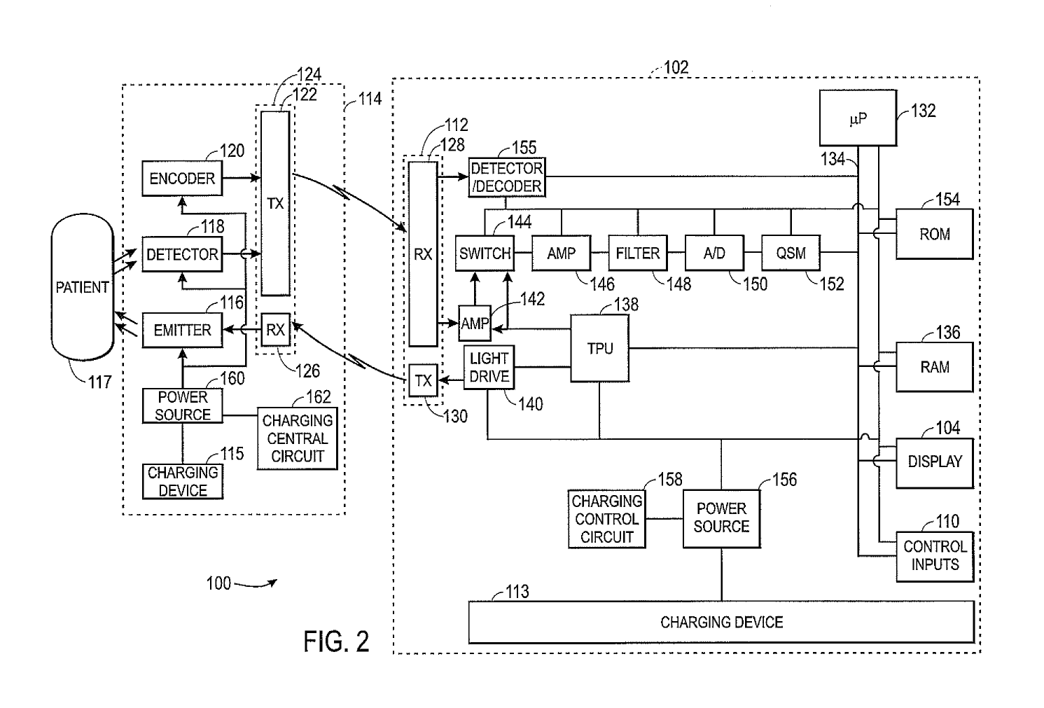

For example, the pulse oximeter 100 may receive electromagnetic charging signals 103A (to monitor 102) and 103B (to sensor 114) from a charging station 105, as well as communicate wirelessly 107A and 107B (from monitor 102 and sensor 114, respectively) with the charging station 105. The charging station 105 may be, for example, a power adapter inclusive of one or more inductors, tuned coils, or a radio frequency transmitter. The wireless communication 107A-B that may take place between the pulse oximeter 100 and the charging station 105 may include a handshake recognition function whereby the charging control circuits (158 and 162 of FIG. 2) of the monitor 102 and sensor 114 may each transmit an identification signal to the charging station 105. This identification signal may, for example, be a radio-frequency identification (RFID) that identifies each element of the pulse oximeter 100 as a device for use with the charging station 105. Until this identification signal is received, the charging station 105 may remain in an “off” state, i.e., not transmitting wireless electromagnetic charging signals 103A-B. The charging station 105 may remain “off”, for example, to reduce overall power consumption until a compatible device is within the range of transmission. Thus, the handshake recognition function between either of the elements of the pulse oximeter 100 (i.e., the monitor 102 or the sensor 114) and the charging station 105 may operate to activate and deactivate the charging station 105.

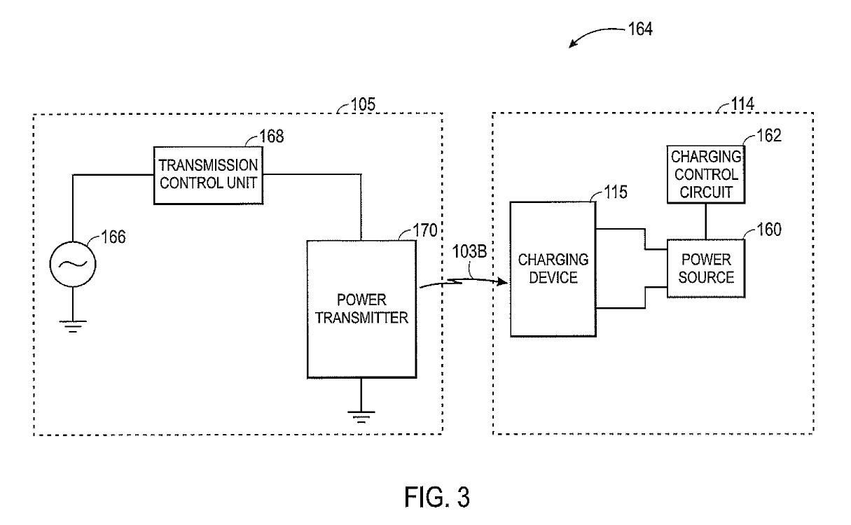

Once a proper identification signal is received, the charging station 105 may be placed into the “on” state. In the “on” state, the charging station 105 may generate and broadcast electromagnetic charging signals 103A-B based on power received via prongs 109 from a power outlet. These prongs 109 may be affixed to the body of the charging station 105 or, alternatively, the prongs 109 may be connected to the charging station 105 via a power cord. Regardless, the prongs 109 may act to receive power from a power outlet for eventual generation of electromagnetic charging signals 103A-B by the charging station 105 when requested by the any element of the pulse oximeter 100, as described below with respect to FIGS. 2 and 3.

Turning to FIG. 2, a simplified block diagram of a pulse oximeter 100 is illustrated in accordance with an embodiment. Specifically, certain components of the sensor 114 and the monitor 102 are illustrated in FIG. 2. As previously noted, the sensor 114 may include a charging device 115. The sensor 114 may also include an emitter 116, a detector 118, and an encoder 120. It should be noted that the emitter 116 may be capable of emitting at least two wavelengths of light, e.g., RED and infrared (IR) light, into the tissue of a patient 117 to calculate the patient's 117 physiological characteristics, where the RED wavelength may be between about 600 nanometers (nm) and about 700 nm, and the IR wavelength may be between about 800 nm and about 1000 nm.

Alternative light sources may be used in other embodiments. For example, a single wide-spectrum light source may be used, and the detector 118 may be capable of detecting certain wavelengths of light. In another example, the detector 118 may detect a wide spectrum of wavelengths of light, and the monitor 102 may process only those wavelengths which are of interest for use in measuring, for example, water fractions, hematocrit, or other physiologic parameters of the patient 117. It should be understood that, as used herein, the term “light” may refer to one or more of ultrasound, radio, microwave, millimeter wave, infrared, visible, ultraviolet, gamma ray or X-ray electromagnetic radiation, and may also include any wavelength within the radio, microwave, infrared, visible, ultraviolet, or X-ray spectra, and that any suitable wavelength of light may be appropriate for use with the present disclosure.

Additionally the sensor 114 may include an encoder 120, which may contain information about the sensor 114, such as what type of sensor it is (e.g., whether the sensor is intended for placement on a forehead or digit) and the wavelengths of light emitted by the emitter 116. This information may allow the monitor 102 to select appropriate algorithms and/or calibration coefficients for calculating the patient's 117 physiological characteristics. Additionally, the encoder 120 may include information relating to the proper charging of the sensor 112. The encoder 120 may, for instance, be a memory on which one or more of the following information may be stored for communication to the monitor 102; the type of the sensor 114; the wavelengths of light emitted by the emitter 116; and the proper calibration coefficients and/or algorithms to be used for calculating the patient's 117 physiological characteristics. The sensor 114 may be any suitable physiological sensor, such as those available from Nellcor Puritan Bennett LLC.

Signals from the detector 118 and the encoder 120 (if utilized) may be transmitted to the monitor 102 via a transmitter 122 that may be located in a transceiver 124. The transceiver 124 may also include a receiver 126 that may be used to receive signals form the monitor 102. As may be seen, the receiver 126 may transmit received signals to the emitter 116 for transmission to a patient 117. The transmitter 122 may receive signals from both the detector 118 and the encoder 120 for transmission to the monitor 120. As previously described, the signals used in conjunction with the emitter 116 and the detector 118 may be utilized for the monitoring of physiologic parameters of the patient 117 while the signals from the encoder may contain information about the sensor 114 to allow the monitor 102 to select appropriate algorithms and/or calibration coefficients for calculating the patient's 117 physiological characteristics.

As previously discussed, the monitor 102 may include a transceiver 112. The transceiver 112 may include a receiver 128 and a transmitter 130. The receiver 128 may receive transmitted signals from the transmitter 122 of the sensor 114 while the transmitter 130 of the monitor 102 may operate to transmit signals to the receiver 126 of the sensor 114. In this manner, the sensor 114 may wirelessly communicate with the monitor 102 (i.e., the sensor 114 may be a wireless sensor 114). The monitor 102 may further include one or more processors 132 coupled to an internal bus 134. Also connected to the bus may be a RAM memory 136 and the display 104. A time processing unit (TPU) 138 may provide timing control signals to light drive circuitry 140, which controls (e.g., via the transmitter 130), when the emitter 116 is activated, and if multiple light sources are used, the multiplexed timing for the different light sources. TPU 138 may also control the gating-in of signals from detector 118 through an amplifier 142 and a switching circuit 134. The amplifier 142 may amplify, for example, the signals from the detector 118 received at the receiver 128. The TPU 138 may control the gating-in of signals from detector 118 through an amplifier 142 to insure that the signals are sampled at the proper time, which may depend at least in part upon which of multiple light sources is activated, if multiple light sources are used. The received signal from the detector 118 may be passed through an (optional) amplifier 146, a low pass filter 148, and an analog-to-digital converter 150 for amplifying, filtering, and digitizing the electrical signals the from the sensor 114. The digital data may then be stored in a queued serial module (QSM) 152, for later downloading to RAM 136 as QSM 152 fills up. In an embodiment, there may be multiple parallel paths of separate amplifier, filter, and A/D converters for multiple light wavelengths or spectra received.

In an embodiment, based at least in part upon the received signals corresponding to the light received by detector 118, processor 122 may calculate the oxygen saturation using various algorithms. These algorithms may use coefficients, which may be empirically determined, and may correspond to the wavelengths of light used. The algorithms may be stored in a ROM 154 and accessed and operated according to processor 122 instructions. The monitor 102 may also include a detector/decoder 155 that may receive signals (via the receiver 128) from the encoder 120. The detector/decoder 155 may, for instance, decode the signals from the encoder 120 and may provide the decoded information to the processor 132. The decoded signals may provide information to the processor such as the type of the sensor 114 and the wavelengths of light emitted by the emitter 116 so that proper calibration coefficients and/or algorithms to be used for calculating the patient's 117 physiological characteristics may be selected and utilized by the processor 132.

The monitor 102 may also include a power source 156 that may be used to transmit power to the components located in the monitor 102. In one embodiment, the power source 156 may be one or more batteries, such as a rechargeable battery. The battery may be user-removable or may be secured within the housing of the monitor 102. Use of a battery may, for example, allow the oximeter 100 to be highly portable, thus allowing a user to carry and use the oximeter 100 in a variety of situations and locations. Additionally, the power source 156 may include AC power, such as provided by an electrical outlet, and the power source 156 may be connected to the AC power via a power adapter through a power cord (not shown). This power adapter may also be used to directly recharge one or more batteries of the power source 156 and/or to power the pulse oximeter 100. In this manner, the power adapter may operate as a charging device 113.

In another embodiment, the charging device 113 may alternately and/or additionally include a wireless charging apparatus that may include, for example, an inductor that wirelessly receives electromagnetic charging signals 103A and generates electrical current as a result of the received electromagnetic charging signals 103B. That is, a current may be electrically induced in the charging device 113 wirelessly. This current may be utilized to directly recharge one or more batteries of the power source 156 and/or to power the monitor 102. Accordingly, the charging device 113 may allow for the pulse oximeter to be used in situations where a power outlet is unavailable near a patient 117.

As may be seen in FIG. 2, the charging device 113 may be positioned lengthwise across the monitor 102, so as to maximize the length of the charging device 113 to aid in increasing the distance at which the charging device 113 may receive and utilize electromagnetic charging signals 103A. In one embodiment, the charging device 113 may be approximately 9 to 10 inches in length. Furthermore, the charging device 113 may be integrated into monitor 102, or, alternatively, the charging device 113 may be affixed externally to the enclosure 111 of the pulse oximeter 100.

The monitor 102 may also include a charging control circuit 158, which may, for example, allow for the adaptive control of wireless energy received from the external charging station 105. The charging control circuit 158 may, for example, include a processing circuit and a transmitter. In one embodiment, the processing circuit may include the processor 132. In another embodiment, the processing circuit may be a separate processor from the processor 132. Regardless, the processing circuit may determine the current level of charge remaining in the power source 156, and may transmit a request, via the transmitter in the charging control circuit 158, for a charging station 105 external to the oximeter 100 to transmit the wireless electromagnetic charging signals 103A used by the charging device 113 to generate an electrical current for recharging of the power source 156.

The charging control circuit 158 may also, for example, determine if the charging device 113 is unable to charge the power source 156. That is, the charging station 105 fails to generate an electromagnetic charging signal 103A for charging of the power source 156, and may generate a corresponding error message for display on the monitor 102. The error message may indicate to a user that the pulse oximeter 100 is low on power and may also direct the user to plug the pulse oximeter 100 into an outlet via the power adapter. This error message may be generated when the charging control circuit 158 determines that the power source 156 has reached a certain charge level, for example, 20% of the total charge remains in the power source 156. The charging control circuit 158 may also perform a handshake recognition function with the charging station 105.

The sensor 114 may also include both a power source 160 and a charging control circuit 162, which may operate in a similar manner to the power source 156 and charging control circuit 158 described above. That is, the power source 160 may be used to transmit power to the components located in the sensor 114. In one embodiment, the power source 160 may be one or more batteries, such as a rechargeable battery that may be user-removable or may be secured within the housing of the sensor 114. The charging device 115 may include a wireless charging apparatus, for example, an inductor that wirelessly receives electromagnetic charging signals 103B and generates electrical current as a result of the received electromagnetic charging signals 103B. That is, a current may be electrically induced in the charging device 115 wirelessly. This current may be utilized to directly recharge one or more batteries of the power source 160 and/or to power the sensor 114.

The sensor 114 may also include a charging control circuit 162, which may, for example, allow for the adaptive control of wireless energy received from an external charging station 105. The charging control circuit 162 may, for example, include a processing circuit and a transmitter for determining the current level of charge remaining in the power source 160, and for transmitting a request, via the transmitter in the charging control circuit 162, for a charging station 105 external to the sensor 114 to transmit wireless electromagnetic charging signals 103B used by the charging device 115 to generate an electrical current for recharging of the power source 160.

The charging control circuit 158 may also, for example, determine if the charging device 115 is unable to charge the power source 160, for example, if a charging station 105 is failing to generate electromagnetic charging signals 103B for charging of the power source 160, the charging control circuit 162 may generate a signal to be transmitted by the transmitter 122 indicating that the sensor is not recharging properly. This signal may cause the processor 132 to generate a corresponding error message for display on the display 104 of the monitor 102. The error message may indicate to a user that the recharging system of the sensor is potentially malfunctioning, and may direct the user, for example, to use replace the sensor 114. This error message may be generated when the charging control circuit 162 determines that the power source 160 has fallen to a certain charge level, for example, to 20% of a total charge of the power source 160. The charging control circuit 162 may also interface with a charging station 105 in a manner similar to the charging control circuit 158, as will be described below with respect to FIG. 3.

The block diagram of FIG. 3 illustrates the components of the charging station 105 and the sensor 114 that may combine to form a wireless inductive power system 164. As illustrated, the sensor 114 may include a charging device 115, a power source 160, and a charging control circuit 162. The charging station 105 may include an alternating current (AC) power converter 166, a transmission control unit 168, and a power transmitter 170. The AC power converter 166 may represent the power that is received from a wall outlet, for example, via prongs 109. This power may be ultimately be transmitted to the power transmitter 170 via the transmission control unit 168.

The transmission control unit 168 may include a receiver and a processing unit. The receiver may receive an identification signal from the charging control circuit 162, and may, as described above, enter an “on” state. Once in the “on” state, the processing unit of the transmission control unit 168, which may be a processor, may await a power transmission request from the charging control circuit 162 of the sensor 114. The charging control circuit 162 may, for example, monitor the charge level of the power source 160 and may transmit a power transmission request when the stored charge of the power source 160 reaches a certain threshold, for example, 40% of the total charge of the power source 160.

Once both the identification signal and the power transmission request, i.e., the wireless communications 107B, have been received by the transmission control unit 168, the transmission control unit 168 may allow power to flow to the power transmitter 170. The transmission control unit 168 may continue to allow power to flow to the power transmitter 170 until a halt power transmission signal is received from the charging control circuit 162. The halt power transmission signal may be generated and transmitted by the charging control circuit 162 when, for example a threshold of charge level is met in the power source 160. For example, this threshold may be approximately 95% of a full charge of the power source 160. Once a halt signal is received, the charging control circuit 162 may operate to prevent the flow of power to the power transmitter 170, thus ending the wireless power transmission to the sensor 114 until a power transmission request is received again. In this manner, the sensor 114 may control the charging of the power source 160 wirelessly. Various wireless powering techniques will be described below.

The power transmitter 170 and the charging device 115 may together form a transformer, that is, an energy transfer mechanism whereby electrical energy is transmitted from the power transmitter 170 to the charging device 115 through inductively coupled conductors. In one embodiment, the inductively coupled conductors may be solenoids, i.e., a metal coil, in each of the power transmitter 170 and the charging device 115. Specifically, a change in current in the inductively coupled conductor of the power transmitter 170 induces a voltage in the conductor of the charging device 115 via generated electromagnetic charging signals 103B. However, because charging signals 103B may radiate in all directions, their intensity may drop off rapidly. Accordingly, the sensor 114 may only be able to be charged when it is at a distance approximately equal to the length of the charging device 115, i.e. within a distance approximately equal to the length of the inductively coupled conductor of the charging device 115. To increase this distance, resonant inductive coupling techniques may be utilized.

Resonant inductive coupling may aid in increasing the transmission distance of the electromagnetic charging signals 103B through the use of at least one capacitor in conjunction with the inductively coupled conductor of the power transmitter 170 and/or the charging device 115. For example, a capacitor and the inductively coupled conductor of the power transmitter 170 may form an LC circuit that may be “tuned” to transmit electromagnetic charging signals 103B at a frequency that resonates with the natural resonance frequency of the inductively coupled conductor of the charging device 115. That is, as electricity travels through the inductively coupled conductor of the charging device 115, the conductor resonates as a product of the inductance of the conductor and the capacitance of the one or more capacitors.

In this manner, energy may be generated at a specified “tuned” frequency that allows for focused energy generation at a specific frequency. By generating energy at this specific frequency, instead of at a plurality of frequencies, the generated electromagnetic charging signal 103B will be stronger, thus allowing for increased range of transmission. For example, by utilizing resonant inductive coupling techniques, the transmission range of the electromagnetic charging signals 103B may increase to approximately 3 to 4 times the length of the inductively coupled conductor of the charging device 115. This distance may allow for a single charging station 105 to be placed, for example, in a wall between two rooms in a hospital or clinic, such that a single charging station 105 might provide wireless power to monitors 102 and wireless sensors 114 in each room. This increase in range may also allow for greater ease in placement of an oximeter 100 near a patient 117 regardless of whether there is a power outlet near the patient 117.

Other techniques for wireless electricity generation and utilization may, be applied in conjunction with the systems described above. For example, magnetic resonance techniques may be applied by the charging station 105 when in communication with, for example, a sensor 114. Magnetic resonant electricity generation may include utilization of near field inductive coupling through magnetic fields, (i.e., magnetic field resonance), to generate wireless electricity. This may be accomplished through the use of two coils, whereby one is located in the power transmitter 170 and the other is located in the charging device 115. Furthermore, one of the coils may be powered, for example, the coil in the power transmitter 170, to generate magnetic resonance. Furthermore, the coils may be tuned, such that magnetic resonance in the powered coil results in a magnetic resonance being generated in the receiving coil (i.e., the coil in the charging device). This may lead to magnetically coupled resonance between the coils whereby the coils resonate at the same frequency to exchange energy efficiently. This exchange of energy may occur to wirelessly power, for example, the sensor 114.

Another technique for the transmission of wireless energy in a wireless inductive power system 164 may include radio frequency (RF) energy transmission. The power transmitter 170 may include a transmitter. This transmitter may broadcast an RF signal at a chosen frequency. This transmission, for example, may travel across several feet of empty space (e.g., through the room of a patient 117) and may be received by a receiver, which may be included in the charging device 115. This receiver in the sensor 114 may be an RF rectenna, that is, a RF rectifying antenna. An RF rectenna may be an antenna used to directly convert RF energy into DC electricity for charging of the power source. Elements of the RF rectenna may include a rectifier disposed between the dipoles of the antenna portion of the rectenna such that the rectifier rectifies the current induced in the antenna by the RF signals. In this manner, RF signals may be harvested and converted to electricity for charging the power source 160 of the sensor 114.

In another embodiment, the monitor 102 may be physically and electrically coupled to the charging station 105 via, for example, a power cable. Accordingly, the transmission control unit 168 and the power transmitter 170 may be located in the monitor 102, e.g., coupled to the charging device 113. In this manner, the monitor 102 may be plugged into the wall to receive AC power and may transmit electricity wirelessly to the charging device 115 in the sensor 114. Accordingly, because the monitor 102 may be in close proximity to the patient 117 (and subsequent sensors 114), the transmission distance and power requirements may be minimized.

It should be noted that while the wireless inductive power system 164 of FIG. 3 was described in conjunction with a sensor 114, other devices may be substituted for the sensor 114 in the wireless inductive power system 164. For example, the charging station 105 may communicate with any number of electronic devices to negotiate the transmission of wireless electricity to the devices. These devices may include, but are not limited to, portable electronic devices, such as a laptop or notebook computers, portable gaming devices, viewable media players, cellular phones, personal data organizers, or the like. Similarly, the electronic devices that may communicate with the charging station 105 to receive wireless electricity may include medical implants, such as pacemakers, or portable pulse oximeters 100 that utilize wireless and/or cord connected sensors 114.

In one embodiment, the charging station 105 may be portable, such that the charging station 105 may be moved closer to a device that will be charged. In the case of the portable charging station 105, a power source, such as a rechargeable battery, may provide the power to transmit the wireless electricity via induction, magnetic resonance, or RF signals. For example, utilization of a portable charging station 105 may be advantageous for use with a patient 117 with a pacemaker implant. The charging station 105 may be placed on the chest of a patient 117 to insure that a pacemaker in the patient 117 is receiving wireless energy to recharge a power source in the pacemaker, in a manner consistent with that set forth above with respect to FIGS. 1-3. Alternatively, the charging station may be placed at a distance from the patient 117, for example, anchored in a wall near the patient 117 such that the wireless energy may still reach the patient 117 and may adequately charge the power source in the medical implant. The use of wirelessly charging a device may be beneficial with respect to medical implants, as replacement of a power source, such as a battery, in the implanted medical device might otherwise require surgery on a patient 117 to replace a depleted power source.

While the disclosure may be susceptible to various modifications and alternative forms, specific embodiments have been shown by way of example in the drawings and have been described in detail herein. However, it should be understood that the embodiments provided herein are not intended to be limited to the particular forms disclosed. Indeed, the disclosed embodiments may not only be applied to measurements of blood oxygen saturation, but these techniques may also be utilized for the measurement and/or analysis of other blood constituents. For example, using the same, different, or additional wavelengths, the present techniques may be utilized for the measurement and/or analysis of carboxyhemoglobin, met-hemoglobin, total hemoglobin, fractional hemoglobin, intravascular dyes, and/or water content. Rather, the various embodiments may cover all modifications, equivalents, and alternatives falling within the spirit and scope of the disclosure as defined by the following appended claims.

What is claimed is:

1. A wireless sensor comprising:
a sensor power source adapted to power the wireless sensor; and
a sensor charging device adapted to receive a wireless electromagnetic charging signal and charge the sensor power source via the wireless electromagnetic charging signal.

2. The wireless sensor, as set forth in claim 1, wherein the wireless sensor comprises a sensor control circuit adapted to transmit an identification signal to initialize the transmission of the wireless electromagnetic charging signal.

3. The wireless sensor, as set forth in claim 2, wherein the sensor control circuit is adapted to monitor an amount of charge for the sensor power source and transmit a power transmission request signal for generating the wireless electromagnetic charging signal when the sensor power source reaches a threshold charge level.

4. The wireless sensor, as set forth in claim 2, wherein the sensor control circuit is adapted to monitor an amount of charge for the sensor power source and transmit a halt power transmission signal for stopping the generation of the wireless electromagnetic charging signal when the sensor power source reaches a threshold charge level.

5. The wireless sensor, as set forth in claim 4, wherein the sensor control circuit is adapted to generate an error indication message when the power source reaches a threshold charge level.

6. A monitor comprising:
a monitor power source adapted to power the monitor; and
a monitor charging device adapted to receive a wireless electromagnetic charging signal and charge the monitor power source via the wireless electromagnetic charging signal.

7. The monitor, as set forth in claim 6, wherein the monitor comprises a monitor control circuit adapted to transmit an identification signal to initialize the transmission of the wireless electromagnetic charging signal.

8. The monitor, as set forth in claim 7, wherein the monitor control circuit is adapted to monitor an amount of charge for the sensor power source and transmit a power transmission request signal for generating the wireless electromagnetic charging signal when the monitor power source reaches a threshold charge level.

9. The monitor, as set forth in claim 7, wherein the monitor control circuit is adapted to monitor an amount of charge for the monitor power source and transmit a halt power transmission signal for stopping the generation of the wireless electromagnetic charging signal when the monitor power source reaches a threshold charge level.

10. The monitor, as set forth in claim 9, wherein the monitor control circuit is adapted to generate an error indication message and displaying the error indication if the power source reaches a threshold charge level.

11. The monitor, as set forth in claim 6, wherein the monitor is adapted to calculate and display physiological parameters.

12. A wireless inductive power system, comprising:
a wireless sensor comprising:
a sensor power source adapted to power the wireless sensor; and
a sensor charging device adapted to receive a wireless electromagnetic charging signal and charge the sensor power source via the wireless electromagnetic charging signal; and
a charging station capable of generating and wirelessly transmitting the electromagnetic charging signal to the sensor charging device.

13. The wireless inductive power system of claim 12 wherein the sensor charging device comprises a resonant inductive charging device comprising a solenoid and at least one capacitor coupled to the solenoid.

14. The wireless inductive power system of claim 12 wherein the sensor charging device comprises a radio frequency antenna comprising two dipoles and a rectifier disposed between the dipoles.

15. The wireless inductive power system of claim 12 wherein the charging station comprises a powered coil and the sensor charging device comprises a second coil tuned in conjunction with the power coil, whereby magnetic resonance generated in the powered coil results in a magnetic resonance being generated in the second coil.

16. The wireless inductive power system of claim 12 wherein the wireless sensor comprises a control circuit capable of:
transmitting an identification signal to initialize the transmission of the wireless electromagnetic charging signal;
monitoring an amount of charge for the sensor power source and transmitting a power transmission request signal for generating the wireless electromagnetic charging signal when the sensor power source reaches a first threshold charge level; and
monitoring the amount of charge for the sensor power source and transmitting a halt power transmission signal for stopping the generation of the wireless electromagnetic charging signal when the sensor power source reaches a second threshold charge level.

17. The wireless inductive power system of claim 16, wherein the charging station comprises a receiver capable of receiving the identification signal, the power transmission request, and the halt power transmission signal.

18. The wireless inductive power system of claim 17, wherein the charging station comprises a processor capable of activating and deactivating the transmission of the electromagnetic charging signal based at least in part on each of the identification signal, the power transmission request, and/or the halt power transmission signal, and/or combinations thereof.

19. The wireless inductive power system of claim 12, comprising:
a monitor comprising:
a monitor power source adapted to power the monitor; and
a monitor charging device adapted to receive the wireless electromagnetic charging signal and charge the monitor power source via the wireless electromagnetic charging signal, wherein the monitor is configured to calculate physiological parameters of a patient, and wherein the charging station is capable of generating and wirelessly transmitting the electromagnetic charging signal to the monitor charging device.

20. The wireless inductive power system of claim 19, wherein the monitor charging device comprises a resonant inductive charging device comprising a solenoid and at least one capacitor coupled to the solenoid.
